(19) United States
(12) Patent Application Publication
(10) Pub. No.: US 2007/0012745 A1
(43) Pub. Date: Jan. 18, 2007

(54) Spring-powered stapler

(76) Inventor: Peigen Jiang, Sammamish, WA (US)

Correspondence Address: Peigen Jiang, 19480 SE 28th Pl, Sammamish, WA, 98075, US

(21) Appl. No.: 11/182,591

(22) Filed: Jul. 14, 2005

(51) Int. Cl. B25C 5/06

(52) U.S. Cl. 227/132

(57) ABSTRACT

A hand operated stapling tool, which uses the energy stored in a spring to install staples by an impact blow, is disclosed. A housing body is preferably cast or molded. A hand lever is pivotally attached to the rear of the body, pressing the hand lever stores energy in a power spring through an actuating lever inside the housing body, and further pressing the hand lever releases the stored energy in an impact blow by a driving blade, which expels a staple down the housing body. A bend on the driving blade engages an actuating lever, and such structure make the stapler more compact. A staple feeding track is formed at the bottom of the housing body, and the stored staples are secured by a rear-hinged panel.

### CROSS-REFERENCES

U.S. Patent Documents

| | | | |
|---|---|---|---|
| 2,326,540 | 8/1943 | Krantz | 1/49 |
| 2,671,215 | 3/1954 | Abrams | 1/49 |
| 2,769,174 | 11/1956 | Libert | 1/49 |
| 3,862,712 | 1/1975 | LaPointe et al. | 227/127 |
| 4,119,258 | 10/1978 | Ewig, Jr. | 227/132 |
| 5,765,742 | 6/1998 | Marks | 227/132 |
| 5,988,478 | 11/1999 | Marks | 227/132 |

### BACKGROUND OF THE INVENTION

1. Field of the Invention

The present invention generally relates to hand-operated fastener applying devices and specifically to spring powered staplers.

2. Description of the Related Art

Various spring-powered staplers employs basically the same operating principle that is to use a spring to store energy, which is then released to drive a blade to expel a staple out of the bottom of the stapler machine. The stapler of the invention also uses this operating principle, but makes the structure more compact and more simplified.

U.S. Pat. No. 5,988,478 issued to Marks discloses a stapling machine in which both a power spring and an actuating level links to a plunger through openings in the plunger. In order to accommodate both links, the size of the plunger has to be large, that makes the hand-operated machine less compact.

U.S. Pat. No. 5,765,742 issued to Marks discloses a stapling machine in which a fastener guide track slidable within the fastener chamber. The separate fastener guide track is a complicated structure, hence costly to manufacture.

U.S. Pat. No. 2,326,540 issued to Krantz discloses a staple gun in which a hand lever is pivoted at the back and an actuating lever engages a vertically positioned spring and driving assembly, and because of that, Krantz's staple gun is quite bulky.

U.S. Pat. No. 2,671,215 issued to Abrams discloses a staple gun with similar vertically placed spring and driving assembly, but a different actuating means.

U.S. Pat. No. 2,769,174 issued to Libert discloses a staple gun in which an actuating means employs two linked levers and spring and driving member assembly vertically positioned.

U.S. Pat. No. 3,862,712 issued to LaPointe et al. discloses a staple gun with a staple feeding track that slides rearward to expose a staple loading chamber. A releasable latch assembly retains the track in position.

U.S. Pat. No. 4,119,258 issued to Ewig, Jr. discloses a staple gun with a body and hand lever constructed substantially of plastic material. Its hand lever is pivoted in the front and its spring and driving assembly is vertically positioned.

### SUMMARY OF THE INVENTION

In the preferred embodiment, a housing body is preferably cast or molded, which houses a driving blade, a power spring with which the driving blade is engaged, a slidable actuating lever that engages the driving blade, and a return spring. The movement of the driving blade is contained in a vertical chamber. A hand lever is hinged on the rear end of the housing body. A staple feeding track is formed at the bottom of the housing body, with a rear-hinged panel snaps to the side walls of the feeding track to prevent staples from falling off the feeding track during operation, and a spring biased pusher to secure the staple(s) to the front of the feeding track.

In order to engage the actuating lever, yet not to take extra space, the driving blade is bent at the top to form a hook. When the hand lever is first pressed, it causes the actuating lever to slide downward and forward, so that the front end of the lifting lever is positioned underneath the driving blade bend. As the hand lever is further pressed, the actuating lever start to rotate, which lifts the driving blade and hence the power spring. This is the stage of storing energy in the power spring. As the driving blade is lifted, it leaves room for a staple being pushed to the front wall of the feeding track, right beneath the driving blade.

In another embodiment, there is a tab on the power spring, and the actuating lever engages only with the power spring through a power spring tab. The driving blade does not engage directly with the actuating lever, and remains a substantially flat sheet.

The driving blade rises in a vertical path in the vertical channel, while the actuating lever rotates in an arc path, as a result, the actuating lever disengage driving blade near the top position as shown. Then the power spring forces the driving blade to move downward instantly, ejecting the staple at the staple exit position in the front of staple feeding track.

When the hand lever is released, the returning spring pushes up the rear-end of the actuating lever and hence the hand lever to their upper most resting position.

A rear-hinged retention panel snaps into the sidewalls of the staple feeding track, which prevents the staple(s) from falling off the feeding track. A spring biased, sliding pusher pushes the staple magazine to the front of the feeding track. In the preferred embodiment, a coiled spring is connected between the front of the retention panel and the sliding pusher. When the retention panel swings open, the coiled spring pulls the sliding pusher to the rear end of the feeding track so that staple magazine can be placed in the front portion of the feeding track. In other embodiments, the sliding pusher can be pushed forward by a pushing coiled spring.

This compact front end gripped and front end staple exiting design of the preferred embodiment can provides the advantage of simplicity and a staple applying action similar to that of a hand-pressed desktop stapler.

### BRIEF DESCRIPTION OF THE DRAWINGS

FIG. 1 is a side elevational view of preferred embodiment stapler, shown in a partial sectional view, of the present invention in a resting position.

FIG. 2 is a side elevational view of the stapler of FIG. 1, just prior to ejection of a staple.

FIG. 3 is a perspective view of the actuating lever, the driving blade and their engagement through a bend on the driving blade.

FIG. 4 is a perspective view of the driving blade with a bend and two openings for engaging the actuating lever and power spring, respectively.

FIG. 5 is a perspective view of the actuating lever, the driving blade and their engagement through a tab on the power spring.

FIG. 6 is a bottom plan view of the stapler with the staple retaining panel snaps to the sidewall of the staple guiding track.

FIG. 7 is a section view of the staple feeding track with a coiled spring pusher inside.

FIG. 8 is a section view of the snap means on the sidewall of the staple feeding.

FIG. 9 is a side plan view of a handle of the staple retaining panel accommodated in a notch on the sidewall of the staple feeding track.

### DETAILED DESCRIPTION OF THE INVENTION

In the following description, numerous details such as specific materials and configurations are set forth in order to provide a more complete understanding of the present invention. However, it is understood by those skilled in the art that the present invention can be practiced without those specific details. In other instances, well-know elements are not described explicitly so as not obscure the present invention.

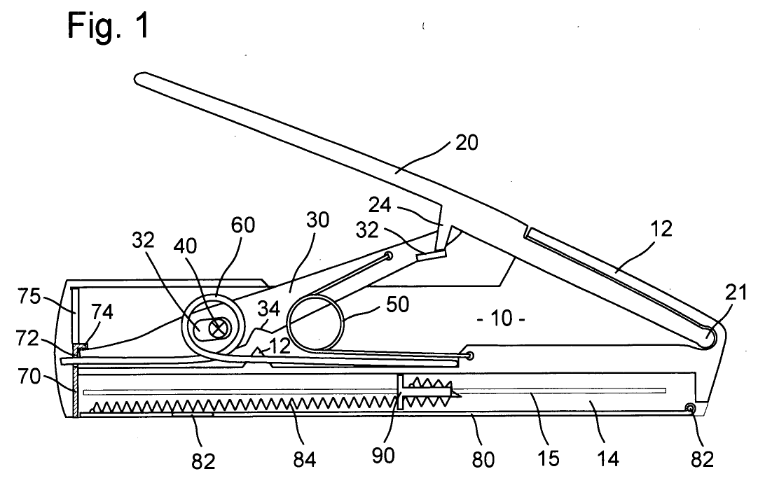

FIG. 1 shows all the essential elements of the present invention. Housing body is shown with one half removed to expose the internal components.

Staple driving blade 70 is contained in a vertical channel 75, and movable within the vertical channel. In order to engage actuating lever 30, driving blade 70 has a bend 74 at it top. The bend 74 is so angled that actuating lever is able to life driving blade 70 and to allow disengagement when driving blade 70 is lifted to the top position.

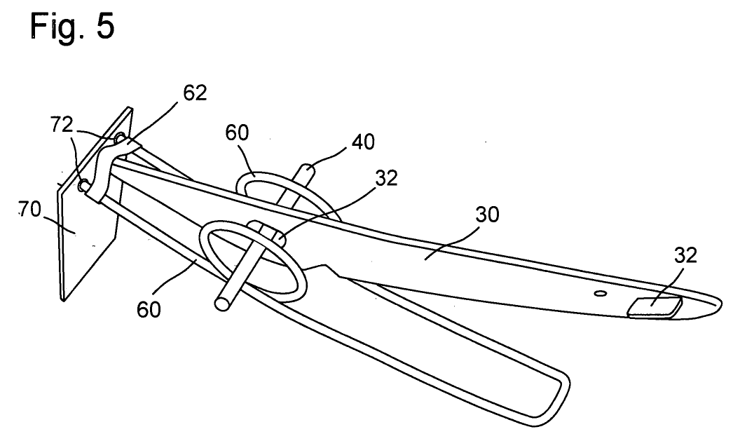

In another embodiment, there is a tab 62 amounted on the power spring as shown in FIG. 5, and the actuating lever engages only with the power spring through tab 62. The driving blade does not engage directly with the actuating lever, and remains a substantially flat sheet.

Power spring 60 links to driving blade 70 through opening(s) 72 on the driving blade, and provides a downward bias upon driving blade 70. The downward motion by power spring 60 and driving blade 70 is limited by housing body 10, so that driving blade 70 does not extrude from the bottom of housing body 10.

Actuating lever 30 is slidably, pivotally mounted on pin 40, which is then fixed on housing body 10.

Hand lever 20 is hinged on the rear end of housing body 10. A column extension 21 from the end of hand lever 20 inserts into a circular slot formed by walls of housing body 10, serving as a hinge for hand lever 20. Top panel 12 of the housing body 10 limits the travel of hand lever 20.

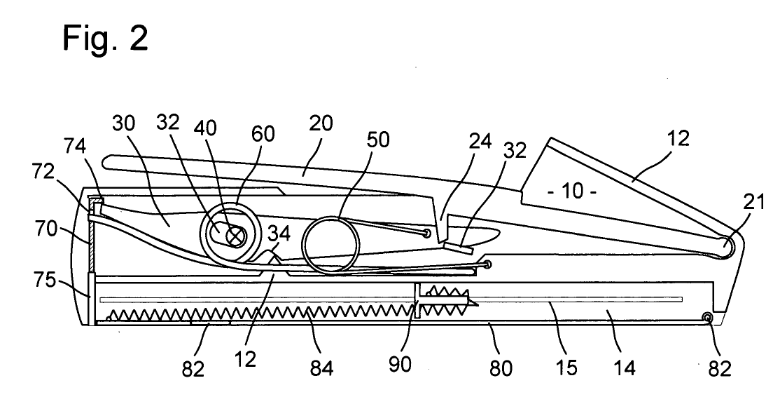

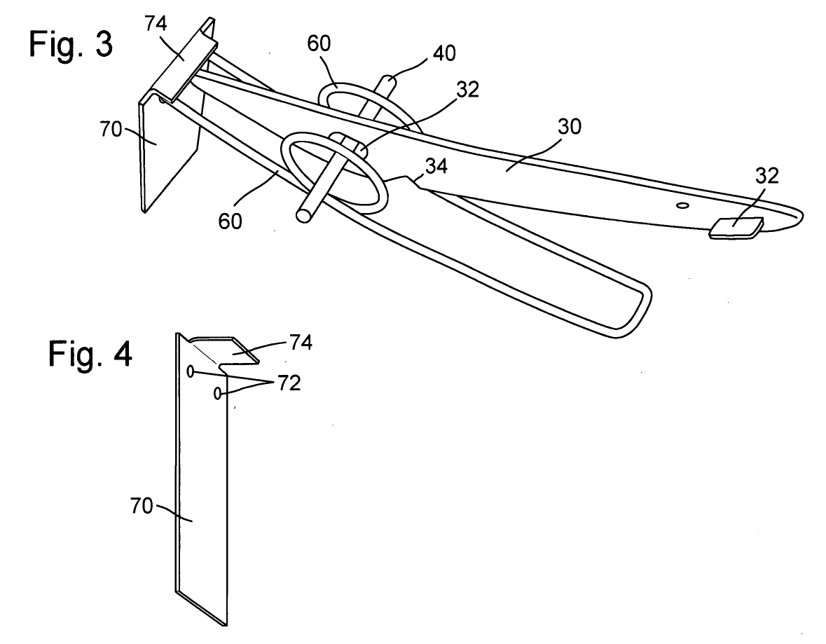

Rib 24 on hand lever 20 engages tab 32 on actuating lever 30. As hand lever 20 is first pressed, actuating lever 30 is pushed downward and forward, and engages driving blade 70 under bend 74. Further pressed down hand lever 20, actuating lever 30 lifts driving blade 70 to the position shown in FIG. 2. The lifting of driving blade 70 leaves room for staple magazine being pushed forward by pusher 90 to the front wall of feeding track 14, and places a frontal staple in the same plane as vertical channel 75 and right beneath the lifted driving blade 70.

Driving blade 70 rises in a vertical path in vertical channel 75, while actuating lever 30 rotates in an arc path, as a result, actuating lever 30 disengages driving blade 70 near the top position as shown in FIG. 2. Then power spring 60 forces driving blade 70 to move downward instantly, expelling the frontal staple down below housing body 10.

In another embodiment, the disengagement of driving blade 70 and actuating lever 30 is achieved through disengagement of rib 24 and tab 32 as shown in FIG. 2. Since downward rotation of hand lever 20 causes rib 24 to shift forward; the resulting rotation of actuating lever 30 causes tab 32 to shift backward, Rib 24 and tab 32 is so sized and placed, when hand lever 20 is pressed down to a certain point, rib 24 and tab 32 will disengage as shown in FIG. 2, then hand lever 20 will no long press actuating lever 30. The pressure of power spring 60 and the pulling of returning spring 50 cause actuating lever 30 slide backward and disengage driving blade 70. With the lifting force removed and actuating lever 30 out of the way, power spring 60 is then released, which forces driving blade 70 downward and expels a staple.

Yet in another embodiment, the disengagement of actuating lever 30 and driving blade 70 is achieved through a notch 34 on actuating lever 30 and a protrusive wedge 12 at the internal surface of housing body 10 as shown in FIG. 1. When the rear side of actuating lever 30 being pressed close to the bottom, the slope of said notch 34 meets wedge 12 as shown in FIG. 2, which forces actuating lever 30 to slide backward at further pressing. In this embodiment, tab 32 on actuating lever 30 and rib 24 on the hand lever are optional.

Return spring 50 exerts an upward and backward bias on actuating lever 30. When hand lever 20 is released, return spring 50 forces actuating lever 30 and hence hand lever 20 back up to their resting position as shown in FIG. 1.

Driving blade 70 includes a vertical portion as a driving blade itself, and a bend 74 as a link to actuating lever 30. The vertical portion of driving blade 70 is a thin sheet metal form that is substantially flat except for small out-of-plane features, which may be incorporated as a design choice. A completely flat portion of driving blade 70 may also be used. Bend 74 is preferable bended at right angle relating to the flat portion of driving blade 70, but can be at any angle from 0 degree to 180 degree relating to the flat portion as long as a link to actuating lever 30 can be established, and disengagement of the two elements is allowed near the top of the range of motion by driving blade 70. The thickness of the sheet metal used to make the driving blade is less than the thickness of a standard staple, and is strong enough to endure the lifting by actuating lever 30.

Feeding track 14 is formed at the bottom of housing body 10. There are guiding slots 15 on each internal sidewall of feeding track 14. Slidable pusher 90 has tabs 92 on both sides, which fit in guiding slot 15 to retain pusher 90 inside feeding track 14 as shown in FIG. 7.

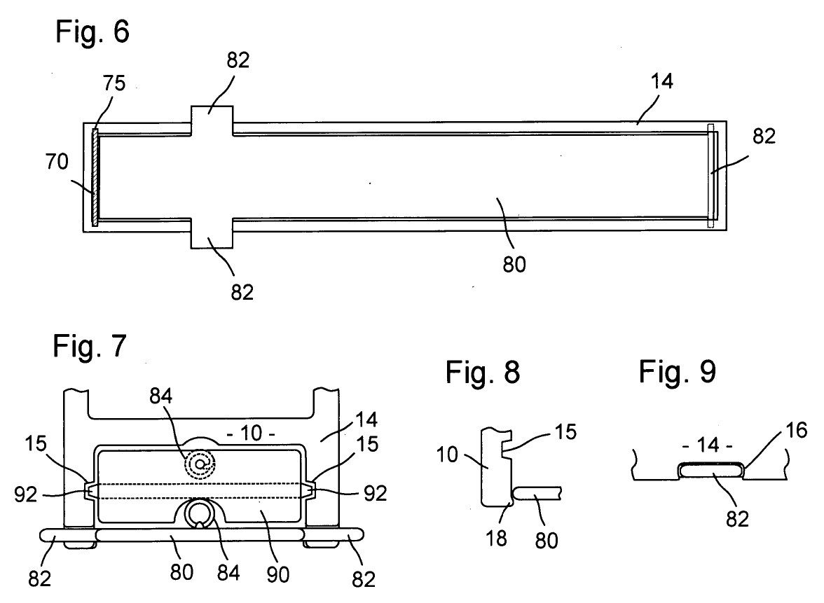

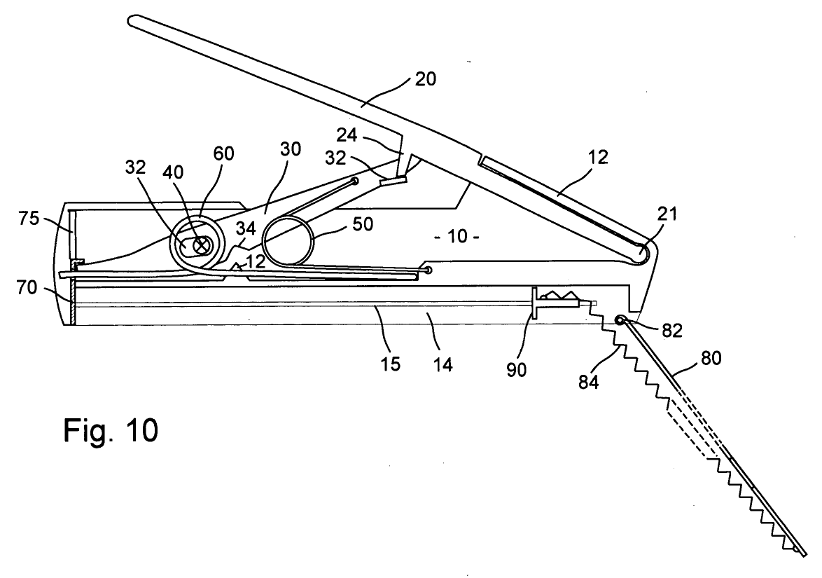

Retention panel 80 snaps to the bottom of feeding track 14 to keep staples inside feeding track 14 during normal operation as shown in FIG. 6. FIG. 8 shows that feeding track 14 has a protrusive profile 18 near the bottom of its sidewalls, and the way how retention panel 80 snaps to the sidewalls. A rear pin 82 formed on retention panel 80 is hinged on the rear end of the sidewalls of feeding track 14 and serves as a hinge for retention panel 80. There is a gap between the front end of retention panel 80 and the front internal wall of housing body 10, which forms a staple exit slot to allow expelled staple exit. Handles 82 on both sides of retention panel 80 fit into notches 16 formed on the bottom sidewalls of feeding track 14, to serve both as a holding place to pull open retention panel 80, and to stop retention panel 80 from being pushed further into feeding track 14. Handles 82 optionally snaps to notches 16.

Retention panel 80 is preferably a thin sheet metal or plastic form, but can also be constructed out of metal wire, as the surface needed to retain staple magazine is only at the two elongated sides of feeding track 14.

Coil spring 84 biases pusher 90 to push staple(s) forward to the front of feeding track 14. The other end of coil spring 84 attaches to retention panel 80. When retention panel 80 being opened, coil spring 84 drags pusher 90 to the back of feeding track 14 as shown in FIG. 10, exposing the chamber of feeding track 14 for placing staple magazine.

What is claimed is:

1. An improved spring-powered stapler of the type, having a housing body to support and guide functional components, a staple feeding track at the bottom of the housing body, a driving blade in the front of the housing body slidably contained in a vertical channel, a power spring linked to the driving blade, a slidably and pivotally mounted actuating lever linked to the driving blade and a rear-end hinged hand lever linked to the actuating lever, wherein the improvement comprises:
Said driving blade includes a projective member at the top for the driving blade being lifted by the actuating lever.

2. The spring-powered stapler according to claim 1, wherein said projective member on the driving blade is so angled to cause engagement with the actuating lever.

3. The spring-powered stapler according to claim 1, wherein the driving blade comprising a thin, flat sheet metal with a bend at the top to form the projective member.

4. The spring-powered stapler according to claim 2, wherein the thickness of said thin, flat sheet metal is less than the thickness of a standard staple wire.

5. An improved spring-powered stapler of the type, having a housing body to support and guide functional components, a staple feeding track at the bottom of the housing body, a driving blade at the front of the housing body slidably contained in a vertical channel, a power spring linked to the driving blade, a slidably and pivotally mounted actuating lever linked to the driving blade and a rear-end hinged hand lever linked to the actuating lever, wherein the improvement comprises:
a tab fixed near the front end of the power spring providing a link means with the actuating lever for biasing the power spring.

6. An improved spring-powered stapler of the type, having a housing body to support and guide functional components, a driving blade at the front of the housing body contained in a vertical channel, a power spring linked to the driving blade, an slidably and pivotally mounted actuating lever linked to the driving blade and a rear-end hinged hand lever linked to the actuating lever, wherein the improvement comprises:
A staple feeding track with an opening for placing staples facing downward, formed at the bottom of said housing body, to feed staples toward a front of said housing body;
A pusher slidable inside the feeding track;
A horizontal channel integral with the internal sidewalls of the feeding track for containing the slidable pusher and allowing the pusher to slide from a front end to near a rear end of said feeding track;
Snap members integral to said feeding track, located at the bottom of the internal sidewalls of the feeding track;
A retention means to retain staples inside the feeding track, with rear edge hinges on a rear end of said feeding track, and two elongated side edges snap to the sidewalls of said feeding track and a front edge short of reaching the front wall of said feeding track leaving a gap for just one staple exit;
A handle means on each side of said retention means extended beyond the sidewalls of the housing body for pulling said retention means swing open;
A notch on the bottom of each sidewalls of the feeding track for accommodating said handle means when the retention means is at closed position, and for preventing the retention means from being pushed further inside said feeding track;
A coil spring residing in the feeding track, with one end attached to the front end of the retention means and a rear end attached to the pusher, and swing open of the retention means causing the pusher being dragged backward, and closing of the retention means causing the pusher being dragged forward to push the staples toward the front of said feeding track.

7. The spring-powered stapler according to claim 6, wherein the retention means comprising a substantially flat panel with protruding tabs on both sides as the handle means.
